(19) United States
(12) Patent Application Publication
(10) Pub. No.: US 2012/0324984 A1
(43) Pub. Date: Dec. 27, 2012

(54) ASSAY METHOD AND APPARATUS

(75) Inventors: James Wakefield, Didcot (GB); Robert Chilcott, Didcot (GB)

(73) Assignee: HEALTH PROTECTION AGENCY, Chilton, Didcot Oxfordshire (GB)

(21) Appl. No.: 13/513,339

(22) PCT Filed: Nov. 30, 2010
(86) PCT No.: PCT/GB2010/051992

§ 371 Date: Sep. 13, 2012

(30) Foreign Application Priority Data
Dec. 1, 2009 (GB) 0921048.5

(51) Int. Cl. G01N 15/08

(52) U.S. Cl. 73/38

(57) ABSTRACT

A skin sample is mounted in a diffusion cell between a receptor and a donor chamber. A substance to be tested is provided to the skin sample via the donor chamber. The diffusion cell has a driver for applying pressure variations to fluid in the receptor chamber in order to cause repeated flexing of the skin sample to simulate the behaviour of living (moving) skin.

This invention relates to assay methods and apparatus for use in such methods, more particularly to methods and diffusion cell type apparatus for providing improved accuracy for in vitro modelling of the dermal absorption of substances including nanoparticles.

### BACKGROUND TO THE INVENTION

This invention addresses a fundamental issue in dermatotoxicology: the lack of an in vitro skin system to more closely represent in vivo dermal absorption conditions.

A Franz cell or diffusion cell is a container with a donor chamber separated from a receptor chamber by a porous membrane or barrier (e.g. skin) located between the chambers and clamped in place. Typically the receptor chamber of a Franz cell container is filled with a receptor fluid which is maintained in contact with the barrier or membrane. A donor substance which may comprise a solid, semi-solid, gas or liquid is placed in the donor chamber and transfer through the membrane can be assessed by measuring the quantity of the donor substance which is present in the receptor liquid. The receptor fluid may comprise water, a solvent, an aqueous solution, a buffered solution or a saline solution.

Franz cells may be employed for testing transdermal absorption of substances. A skin sample is disposed between the donor chamber and the receptor chamber containing a receptor liquid. In this model the receptor liquid corresponds to the papillary plexus, and as such compounds which penetrate the skin section to enter the receptor fluid can reasonably be expected to penetrate skin in vivo and therefore, can be made available to the systemic circulation by application to the skin. Diffusion cells and assay methods using such cells therefore provide an assessment of the bioavailability of a compound following dermal absorption.

It has been proposed to maintain constant pressure in the receptor fluid and include means for controlling flow of receptor fluid. It has also been proposed to couple high accuracy extraction pumps to Franz cells in order to remove small volumes of liquid from the receptor chamber for measuring. Typically volumes on the order of a micro litre (μl) (10⁻¹⁵ m³) are dispensed from the chamber. In such systems an inlet capillary may be provided to replace fluid volume removed for measurement.

To provide an in vitro model of improved accuracy and reliability it is desirable to simulate more closely the conditions encountered when a compound is applied to living skin.

### SUMMARY OF INVENTION

Aspects and preferred examples of the invention are set out in the claims.

An aspect of the invention provides a vessel for diffusion cell, the vessel comprising a driver arranged to drive motion of a membrane (eg. a mounted skin section). This has the advantage of providing a diffusion cell operable to simulate the flexing and stretching of the skin that occurs in vivo.

A diffusion cell comprises a receptor chamber for holding fluid. This enables a membrane (eg. a skin section) held in the diffusion cell to be kept in contact with particular receptor fluid media. In general the receptor chamber has an orifice over which the membrane can be clamped, for example using a clamp or other mounting. When clamped in place the membrane covers the orifice to close the chamber. Preferably the driver is operable to displace said receptor chamber fluid to drive motion of the skin section. This has the advantage of providing motion of the membrane without applying highly localised mechanical force to the membrane. As will be appreciated applying highly localised force repetitively may damage and possibly even tear the membrane causing the assay to fail.

In one embodiment a force may be applied to the membrane in a cyclic fashion, such as in a sinusoidal fashion and variations thereof. Accordingly, the observed membrane movement may be, for example cyclic or sinusoidal.

Reference to ‘motion’ of the membrane, of course, refers to an ‘up’ and/or ‘down’ movement of the membrane when the receptor is orientated in its usual position of use as illustrated in the Figures. Put another way, the ‘down’ direction of membrane movement is the direction that corresponds to the minimum distance of travel of a test compound/substance across the membrane during performance of the assay.

In one embodiment displacing fluid may comprise varying the capacity (total internal volume) of the receptor chamber. In one embodiment the driver is operable to displace a fluid volume and/or change the internal capacity of the chamber corresponding to a volume of between 0.01 ml and 2 ml (eg. between 0.001 ml and 0.5 ml). In another embodiment the driver is operable to displace a fluid volume and/or change the internal capacity of the chamber corresponding to a volume of between 0.02 ml and 1.5 ml (eg. between 0.02 ml and 0.7 ml). In another embodiment the driver is operable to displace a fluid volume and/or change the internal capacity of the chamber corresponding to a volume of between 0.03 ml and 1.5 ml (eg. between 0.03 ml and 0.9 ml). In another embodiment the driver is operable to displace a fluid volume and/or change the internal capacity of the chamber corresponding to a volume of between 0.04 ml and 1.1 ml. In another embodiment the driver is operable to displace a fluid volume and/or change the internal capacity of the chamber corresponding to a volume of between 0.04 ml and 1 ml (eg. between 0.1 ml and 0.7 ml). In another embodiment the driver is operable to displace a fluid volume and/or change the internal capacity of the chamber corresponding to a volume of between 0.06 ml and 1 ml (eg. between 0.2 ml and 0.9 ml). In another embodiment the driver is operable to displace a fluid volume and/or change the internal capacity of the chamber corresponding to a volume of between 0.08 ml and 1.2 ml (eg. between 0.3 ml and 1 ml). The selected capacity changes have the advantage of providing flexing and stretching of a mounted membrane (e.g. skin sample) without damaging it and maintaining it in contact with the receptor fluid. Optionally the capacity change can be selected with reference to the size of the orifice and the desired displacement of the membrane dependent on the desired range of movement. As will be appreciated in the context of the present application the capacity change and/or the pump displacement volume are selected based upon the desired degree of membrane flexion/displacement, the orifice diameter and the durability and elastic properties (e.g. elastic modulus) of the membrane under test.

In one embodiment, the membrane is a tissue sample (eg. an animal tissue sample such as a pig or human tissue sample). Preferably the tissue is a skin section, for example a section of excised pig or human skin. In this regard, convenient sources skin samples include hospitals performing skin surgery such as abdominoplasty or breast reduction. However, as will be appreciated, the method may be applied to any tissue or membrane. For example, artificial skin alternatives are readily available commercially, such as those provided by Skin Ethic Laboratories (Lyon, France).

Artificial skins are typically produced by culturing human keratinocytes on a collagen base in conditions to promote terminal differentiation and reconstruction of the epidermis with a functional horny layer. These primary human keratinocytes are obtained, for example, from mammary/abdominal samples from plastic surgery donors. Reconstituted human epidermis (RHE) follows the same principles, and is produced from normal human keratinocytes cultured on an inert polycarbonate filter at the air-liquid interface. RHE is generally considered (by those in the art) as being a good equivalent (histologically) to an in vivo human epidermis.

The method of the present invention may be applied in a diffusion cell comprising: a receptor chamber for holding a fluid and the force may be applied using the receptor fluid. Typically the chamber will have an orifice surrounded by a flange to enable a membrane (eg. a skin section) to be secured to the orifice, for example using a clamp. The method may comprise causing a variation of fluid pressure in the receptor chamber to apply force to the membrane. In some examples the pressure variation is cyclic, for example sinusoidal. These methods have the advantage of modifying the behaviour of the membrane to account for natural movement that occurs in vivo. This is of particular advantage in studies of penetration of compounds into skin because it can account for the enhancement of the penetration of nanoparticles into the skin via the intercellular spaces.

In one embodiment the driven motion includes a flexing motion of the membrane (eg. skin section) and may be a cyclic and/or oscillatory motion such cyclic and/or oscillatory motion may be periodic, aperiodic or intermittent. By way of example, the average cycle time may be 0.1 second, 1 second, between 1 and 10 seconds and 20 seconds, between 30 seconds and 1 minute. In one embodiment the average cycle time is between 50 seconds and 1 minute 20 seconds dependent on the level of motion that is required to be simulated. As will be appreciated in the context of the present application a suitable rate of flexing is selected dependent on the particular circumstances being modelled. Use of a cyclic or intermittent motion of the membrane has the advantage of allowing behaviour of the tissue model to be modified using a measurable parameter which is straightforwardly controlled. In one embodiment the selected cycle time is on the order of minutes, for example 2 minutes, 4 minutes 6 minutes or 20 minutes. This has the advantage of simulating slower (or more infrequent) flexing of the membrane. In one embodiment the motion of the membrane is controlled to as not to be so rapid as to induce damage to the membrane or adversely affect the test compound. The lower limit on the speed of motion induced in the membrane is selected to prevent the membrane behaving as if it is static. This is likely to give a cycle time range of between seconds and minutes.

In one embodiment motion causes extension (a degree of stretching) of the membrane sample. By way of example, the percentage extension associated with its driven motion may be less than 0.01%, less than 5%, or, in one embodiment less than 10%; in another embodiment less than 30% or 50%. As will be appreciated in the context of the present invention the degree of extension is selected based upon the parameters of the system being modelled (e.g. the behaviour of the in vivo skin type in question) and based upon the properties of the membrane to prevent/minimise damage by overstretching. The selected percentage ranges are merely examples and, as will be appreciated in the context of the present invention, each example provides particular advantages under different circumstances and dependent on the tissue system being simulated and, advantageously, the present invention enables the skilled practitioner to select the range appropriate to a particular circumstance/system.

In one embodiment, reference to percent (%) extension means the maximum distance of membrane displacement in a single direction relative to the resting position of the membrane (ie. when the membrane is not subjected to flexing motion), and wherein 100% extension represents the maximum distance of membrane displacement at which point the membrane becomes damaged (eg. the membrane can no longer be used in a reliable and repeatable manner in accordance with the invention, or tears, or stretches beyond its elastic limit). In another embodiment, 100% extension may represent the maximum thickness of the membrane (eg. in a direction represented by the shortest distance that a test compound/substance travels when crossing the membrane during an assay of the present invention).

In one embodiment, the membrane is driven to deflect from its equilibrium position by a deflection which exceeds 0.05 mm, 0.1 mm, 0.2 mm, 1 mm and in some examples it may exceed 2 mm. In one embodiment the membrane is displaced from its equilibrium position by up to 50 mm or 1 cm or 2 cm. As will be appreciated, a particular deflection of the membrane may be selected to simulate particular conditions in vivo.

In one embodiment the receptor chamber is fluidly coupled to a piston pump or a piston pump is formed integrally with the receptor chamber, for example in a wall of the receptor chamber. In these examples a simple linear actuator, or an electric motor coupled to a reciprocating arm can be used to accurately control a capacity change in the receptor chamber. Alternatively, the receptor chamber may have a movable portion, such as a movable wall, that can be driven inwards in the manner of a syringe, alternatively the movable portion may include a flexible or compressible (e.g. concertinaed) wall. In one embodiment an inflatable member such as a bladder, rather in the manner of a balloon, is provided within the receptor chamber, the interior of the inflatable member being fluidly coupled to a controllable pressure pump so that inflation and/or deflation of the inflatable member causes a corresponding capacity/pressure change in the receptor chamber. In one embodiment a modified sampling arm or sampling arm cap is provided so that a standard diffusion cell can be modified to operate in accordance with the invention (for example by providing a driver in or coupled to the sampling arm cap). As will be appreciated, these are just examples and any appropriate means operable to provide a cyclic capacity and/or pressure change in the receptor chamber may be used.

In one embodiment gases are excluded from the receptor chamber so that the fluid content of the receptor chamber is substantially incompressible. These examples have the advantage of providing a predictable application of force/pressure to the membrane (eg. skin section) in response to a particular change in the internal capacity of the receptor chamber (the receptor chamber being closed by a skin section). Typically a diffusion cell includes a sampling arm for the collection of receptor fluid samples during studies. In examples of the invention the sampling arm has a screw-threaded cap to prevent escape of receptor fluid from the sampling arm. Preferably the sampling arm is capped with no head space of air this movement causes the membrane to flex outwards.

In one embodiment the driver includes a mechanical driver for applying driving force to the skin section, for example via a clamp. This has the advantage that pre-existing diffusion cells can be used. A mechanical driver may be an electromechanical actuator (e.g. an actuator including a solenoid or being similar to a loud speaker, or including one or more piezoelectric elements) coupled mechanically to the skin section, for example via the clamp.

In one embodiment a hydraulic piston connects to the receptor chamber. The piston is controlled by a hydraulic pump system of which the movement can be finely controlled. The sampling arm which allows collection of the receptor fluid samples during studies has a screw-threaded cap to prevent escape of receptor fluid from the sampling arm. When a membrane (eg. an excised skin section) is mounted in this instrument, outward movement of the piston will result in receptor fluid moving out of the receptor chamber. As the sampling arm is capped with no headspace of air, this movement causes the membrane to flex inwards as shown in FIG. 2A. Conversely, movement of the piston inwards moves fluid into the receptor chamber giving rise to an outward flexing of the membrane as shown in FIG. 2B. Repeated motion of the piston inwards and outwards results in a cyclical flexing of the membrane inwards and outwards.

In one embodiment the receptor chamber is jacketed with a fluid jacket to provide temperature control of the receptor chamber. Examples of the invention have the advantage that the skin section can be maintained under prescribed conditions, for example at particular temperature, and/or with particular receptor fluid media which enable an accurate assessment of dermal absorption, whilst also allowing membrane movement.

The diffusion cell is preferably an OECD (Organisation for Economic Co-operation and Development) compliant diffusion cell, modified to allow movement of the membrane and, therefore, any results obtained using this system may be directly comparable to those results obtained using standard non-flexing diffusion cells. In this regard, the OECD 428 Guidelines for Skin Absorption (in vitro) require that a diffusion cell must comprise two chambers, the donor chamber and the receptor chamber, which provide a good seal around the membrane. The Guidelines also require that the cell permits easy sampling, good mixing of the receptor solution which is in contact with the underside of the membrane, and good temperature control of the cell and its contents.

In one embodiment, typical orifice diameters include 5 mm, 7 mm, 9 mm, 11.28 mm, 15 mm, 20 mm and 25 mm, although other diameters may be provided. As will be appreciated the word “orifice” as it refers to a Franz Cell is the area at the top of the receptor chamber that is exposed to the membrane through which transport or permeation is being studied. Preferably a clamp is provided for clamping a skin section or skin section over the orifice to close the receptor chamber. Typically a Franz cell receptor chamber has a capacity of between 5 ml and 20 ml although other volumes may be provided.

By way of example, one embodiment of the invention is to use a hydraulic piston connecting to the receptor chamber. The piston is controlled by a hydraulic pump system of which the movement can be finely controlled. This has the advantage of providing precise control of the pressure variations applied to the membrane.

In one embodiment the driver is an hydraulic peristaltic pump alternating between forward and reverse drive motion. This and other examples of the invention permit the displacement of a membrane under test to be controlled with high precision and reproducibility to ensure that results can be replicated between studies and to facilitate comparisons between results obtained in different studies. As will be appreciated in the context of the present invention the exact amplitude (volume displacement) and reciprocation frequency is selected according to the parameters of the system being modelled/simulated by the diffusion cell.

In one embodiment a membrane (eg. a skin sample) is mounted in a diffusion cell between a receptor and a donor chamber. A substance to be tested is provided to the membrane via the donor chamber. The diffusion cell has a driver for applying pressure variations to fluid in the receptor chamber in order to cause repeated flexing of the membrane to simulate the behaviour of living (moving) skin.

In one embodiment, the method of the invention further comprises analysing the transmembrane transport of a test molecule/substance (eg. a nanoparticle or nanomaterials). Said analysis may include calculating the amount of test molecule/substance that has passed across the membrane (eg. over a defined period of time).

In one embodiment this may be a simple assessment of the amount of test molecule/substance appearing in the fluid after passage across the membrane versus the amount of test molecule/substance applied to the membrane. Multiple variations (in terms of the type of analysis) are well known to a skilled person and simply depend on the type of investigation being performed and/or the data output desired. Other (optionally additional) types of analysis include analysing the membrane to identify specific localisation of test compounds/substances within the various regions/layers of the membrane. To assist detection, the test molecules/substances may be labelled (eg. with flurophores, or radiolabels)—appropriate labels and associated methodologies are well known to a skilled person.

Embodiments of the invention may have application for risk assessment (e.g. dermal exposure to pesticides), regulatory submissions (e.g. evaluation of bioequivalence and bioavailability of topical pharmaceuticals), the development of new transdermal drug delivery systems and basic studies into normal skin physiology (e.g. transepidermal water loss).

The device and method of the present invention provide a more accurate and reproducible in vitro model that incorporates the extra dimension of membrane flexion in order to correctly assess potential dermal delivery (eg. of hazardous molecules). Said device and method allow careful and accurate assessment of whether chemicals/substances (eg. nanoparticles) are able to traverse the epidermal layer when skin flexion energy and movement is taken into account. In addition, the device and method of the invention permits determination of the route these particles take through the stratum corneum.

As the use of nanoparticles and nanotechnology increases, it is important to ensure that any risks posed to animal (eg. human) health are correctly identified. The prior art commercially available in vitro systems lack this fundamental flexion aspect, which is believed (by the present inventor) to lead to inaccurate assessments of the likely uptake of nanoparticles through the dermal route (in particular leading to underestimates). This is of paramount important consideration when assessing the risk that nanoparticles may pose to animal (in particular human) health. Nanoparticles such as titanium dioxide and zinc oxide are already present in many cosmetics such as sunscreens to prevent absorption of UV, which causes skin damage. Said cosmetics employ nanoparticle formulations as they provide better dispersion across the skin surface. Thus, the present invention (also referred to as the Cutaflex™ system) may be readily employed within industries such as the cosmetics industry to assess the uptake of compounds/substances (eg. nanoparticles) from formulations (such as cosmetics formulations, for example sun screens/lotions) to provide safely testing (eg. during regulatory approval) prior to commercialisation, thereby ensuring safety of the consumer. The pharmaceutical industry is also developing formulations containing compound/substances (eg. nanoparticles/nanomaterials) to aid with transdermal delivery of active pharmaceuticals. Examples of such formulations include patches, creams, etc. Accordingly, the device and method (Cutaflex™) of the present invention has application in said pharmaceutical settings to assess transdermal safety and/or efficacy—the present invention represents a significant improvement over the current in vitro testing strategies, which are sub-optimal.

### SUMMARY OF DRAWINGS

An embodiment of the invention will now be described in greater detail, by way of example only, with reference to the drawings in which:

FIG. 1 shows a cross sectional representation of a diffusion cell including a piston driver; and

FIGS. 2A and 2B show the diffusion cell of FIG. 1 in use.

### DESCRIPTION

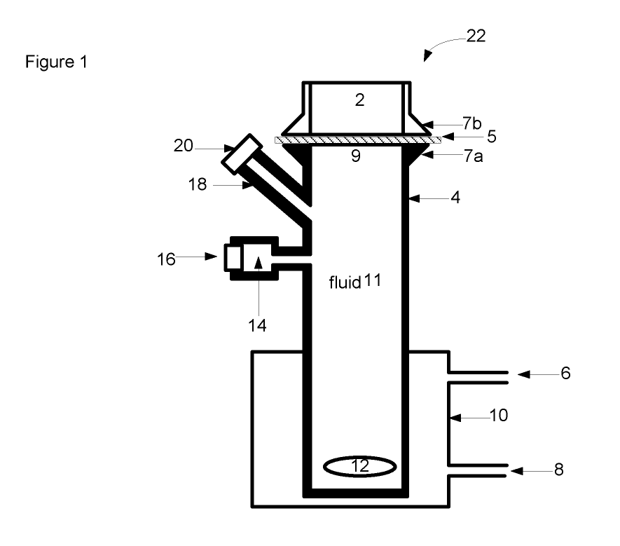

FIG. 1 shows a diffusion cell 22 having a donor chamber 2 and a receptor chamber 4. The donor chamber 2 and the receptor chamber 4 each have an opening or orifice 9 bounded by a flange 7a, 7b.

A sampling arm 18 extends from the receptor chamber 4 and is provided with a threaded fitting for engaging with a threaded sampling arm cap 20.

A water jacket 10 surrounds a body portion of the diffusion cell 22 and has a water inlet 8 and a water outlet 6 to allow for the circulation of water to control the temperature of the receptor chamber fluid 11 via heat exchange through the walls of the receptor chamber 4. As shown the water jacket 10 surrounds only a part of the receptor chamber. It may however be designed to surround the entirety of the receptor chamber. Preferably the water jacket covers the majority of the receptor chamber to improve thermal contact with the receptor clued because this lowers the temperature required in the water jacket to produce a constant (˜32° C.) temperature at the skin surface. However the presence of the sampling arm and pump mean that it is not always possible to surround the entire receptor chamber in the water jacket

A piston chamber 14 containing a piston 16 is fluidically coupled to the receptor chamber 4.

A magnetic stirrer 12 may be provided in the receptor chamber for coupling with a magnetic driver (not shown) to provide an impeller so that the receptor chamber fluid 11 can be stirred without opening the receptor chamber 4.

In use of the diffusion cell, a sample to be tested, in this example an excised skin section or sample 5, is positioned between the receptor and donor chambers so as to separate the donor chamber 2 from the receptor chamber 4 and the flanges 7a and 7b are fastened together so that a peripheral portion of the skin sample is trapped between opposed flat faces of the flanges 7a and 7b so the skin sample 5 is held taut. The flanges may be fastened together by any suitable fastening mechanism such as one or more clamps or one or more screws or bolts.

In the example illustrated in FIG. 1, the receptor chamber 4 is filled with a receptor fluid so that the skin sample 5 is in contact with the receptor fluid and the piston chamber 14 and the sampling arm 18 are also filled with fluid and capped with no headspace of air. The receptor fluid may comprise water, a buffered solution or a saline solution or tissue culture media, or a solvent: water mix e.g. Ethanol:Water.

The piston 16 is driven back and forth within the piston chamber When the piston 16 is driven inwards towards the receptor chamber 4 with the sampling arm cap 20 closed, the resulting displacement of receptor chamber fluid 11 exerts increased pressure on the skin sample causing it to bow towards the donor chamber 2. Conversely, when the piston 16 is driven back away from the receptor chamber 4 with the sampling arm cap 20 closed, receptor chamber fluid 11 is drawn into the piston chamber so reducing the pressure on the skin sample 5. This may simply return the skin sample to its initial flat state or may if the piston is driven beyond its initial starting point cause the skin sample to bow towards the receptor chamber.

Bowing or flexing of the skin sample is thus achieved by varying the combined internal capacity of the receptor chamber, sampling arm and piston chamber while holding the receptor chamber closed with a section of excised skin.

The donor chamber will in practice be supplied with a substance applied to the skin surface.

Diffusion cell studies may have a duration of a few hours or a few days and to simulate flexing and stretching of the skin over this period many cycles of the above described inward and outward flexing of the skin may be performed. Each cycle has a duration selected according to the system being simulated.

As will be appreciated references to the capacity of the receptor chamber relate to the volume capacity.

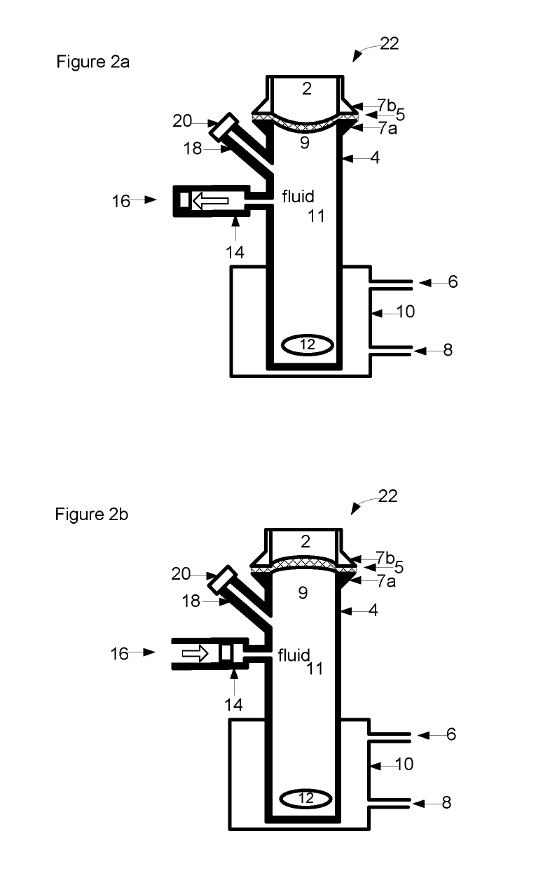

In other words, when an excised skin section is mounted in the diffusion cell inward movement of the piston will result in receptor fluid moving into the receptor chamber and displacing the membrane. Movement of the piston outwards gives rise to movement of receptor fluid from the receptor chamber giving rise to a downward flexing of the skin section. Continuous motion of the piston inwards and outwards results in a cyclical flexing of the skin inwards and outwards. These cycles of motion are illustrated in FIGS. 2A and 2B in which reference numerals used above with reference to FIG. 1 indicate corresponding elements.

Although the examples described above with reference to FIGS. 1, 2A and 2B concern a hydraulic piston, the invention includes other physical and mechanical methods of flexing the skin in a diffusion cell. For example a piezo electric element may be mounted in an assembly coupled to one or both of the flanges 7a and 7b. An example of a piezo electric assembly for this purpose is a ring for mounting a membrane wherein the ring comprises one or more piezoelectric elements such that application of electric current causes flexion, expansion or contraction of the ring thereby extending and/or flexing of a membrane mounted to the ring. Alternatively an actuator driven by a piezoelectric element or a solenoid may be mounted adjacent one or both of the flanges, and is operable to apply a force to a membrane mounted between the flanges For example such an actuator may apply an impulse force to the membrane (rather in the manner of a hammer and a drum) or be coupled to the membrane to depress it into the receptor chamber and or pull it outwards from the chamber. For this purpose pairs of actuators may be provided, one on each side of the membrane, each arranged to apply a force to the membrane so that it can be pushed outwardly and inwardly into an out of the diffusion cell by the actuators. Alternatively an actuator may be coupled to the membrane using a magnetic member. In other words a magnet, much like a magnetic stirrer is positioned on one side of the membrane and a magnetic actuator is arranged on the other side of the membrane. In such an arrangement when the actuator pushes in one direction the membrane is pushed in that direction and when the actuator is pulled in the other direction the magnetic member is pulled by the magnetic actuator with the membrane sandwiched between the actuator and the magnetic member (held in place by the magnetic attraction between the two. In one embodiment the driver is an hydraulic peristaltic pump alternating between forward and reverse drive motion.

Alternative examples of methods of driving a membrane in a diffusion cell will be apparent to the skilled practitioner in the context of the present application.

1. A method of performing an assay on a membrane mounted in a diffusion cell, wherein said diffusion cell comprises a receptor chamber, the method comprising providing a fluid in the reception chamber such that the membrane is in contact with the fluid and applying a force to the membrane by varying the capacity (total internal volume) of the receptor chamber to cause repeated deformations of the membrane; wherein the membrane is skin or artificial skin and wherein said force does not damage the membrane by overstretching.

2. (canceled)

3. The method of claim 1 comprising arranging said membrane to close an orifice of the receptor chamber and varying the fluid capacity of the receptor chamber to apply the force to the membrane.

4. The method of claim 1 wherein the force is applied substantially cyclically.

5. The method of claim 1 wherein the repeated deformations provide a cyclic motion of the membrane.

6. The method of claim 4 wherein the force is applied in a cyclic manner chosen from the list comprising: periodic, aperiodic and intermittent.

7. The method of claim 6 wherein the average cycle time is chosen from the list comprising 0.1 second, 1 second, between 1 and 10 seconds and 20 seconds, between 1 and 30 seconds and between 50 and 70 seconds.

8. The method of claim 1 wherein each of the repeated deformations is substantially identical.

9. The method of claim 1 wherein at least one of the amplitude and frequency of the repeated deformations are varied.

10. (canceled)

11. A diffusion cell comprising: a receptor chamber and a donor chamber adjacent the receptor chamber each chamber having an opening such that a membrane can be arranged between the chambers to separate the chambers, the diffusion cell comprising a driver operable to cause motion of said membrane by varying the capacity (total internal volume) of the reception chamber; and wherein the membrane is skin or artificial skin and wherein said motion does not damage the membrane by overstretching.

12. A diffusion cell according to claim 11 wherein the receptor chamber is for holding a liquid and wherein, in use, said membrane is mounted in contact with said liquid.

13. A diffusion cell according to claim 11 wherein the driver is operable to displace said liquid to cause motion of said membrane.

14. A diffusion cell according to claim 11 wherein the driver is disposed in a driver chamber fluidly coupled to the receptor chamber.

15. A chamber for a diffusion cell comprising an opening for receiving a membrane and a driver arranged to drive motion of said membrane by varying the capacity (total internal volume) of the reception chamber; and wherein the membrane is skin or artificial skin and wherein said motion does not damage the membrane by overstretching.

16. The chamber of claim 15 adapted for holding a fluid such that, in use, said membrane contacts said fluid.

17. The chamber of claim 15 wherein the driver is operable to displace said fluid to drive motion of said membrane.

18. The chamber of claim 17 wherein displacing said fluid comprises changing the fluid capacity of the receptor chamber.

19. The chamber of claim 17 comprising a driver chamber fluidly coupled to the receptor chamber, the driver being arranged in the driver chamber and wherein changing the fluid capacity of the receptor chamber comprises changing the fluid capacity of the driver chamber.

20. The chamber of claim 17 wherein the driver is operable to drive the membrane by displacing a fluid volume of between 0.01% and 50% of the receptor volume, for example wherein the driver is operable to drive the membrane by displacing a fluid volume of between 0.01 ml and 0.5 ml.

21. The diffusion cell of claim 11 wherein the driver is operable to drive a substantially cyclic motion of said membrane.

22. The diffusion cell of claim 11 wherein the driver is operable to drive a substantially cyclic motion having an average cycle period of between 0.1 of a second and 2 minutes.

23. The diffusion cell of claim 11 wherein the driver is operable to displace a fluid volume selected to provide a desired transverse displacement of the membrane.

24. The diffusion cell of claim 11 wherein the driver comprises a piston pump.

25. The diffusion cell of claim 11 in which the driver comprises a mechanical actuator actuable to apply a force to the membrane.

26. (canceled)

27. A diffusion cell comprising: a receptor chamber for holding fluid, the chamber having an orifice; the orifice being adapted to be covered by a membrane to close the chamber; and a piston operable to provide a cyclic change of the capacity (total internal volume) of the receptor chamber; and wherein the membrane is skin or artificial skin and wherein said motion does not damage the membrane by overstretching.

28. (canceled)

29. The chamber of claim 15 wherein the driver is operable to drive a substantially cyclic motion of said membrane.

30. The chamber of claim 15 wherein the driver is operable to drive a substantially cyclic motion having an average cycle period of between 0.1 of a second and 2 minutes.

31. The chamber of claim 15 wherein the driver is operable to displace a fluid volume selected to provide a desired transverse displacement of the membrane.

32. The chamber of claim 15 wherein the driver comprises a piston pump.

33. The chamber of claim 15 wherein the driver comprises a mechanical actuator actuable to apply a force to the membrane.
